(19) United States
(12) Patent Application Publication
(10) Pub. No.: US 2026/0350293 A1
(43) Pub. Date: Nov. 5, 2026

(54) SYSTEMS AND METHODS FOR STANDARD CODING AND GUIDELINE INGESTION

(71) Applicant: PALANTIR TECHNOLOGIES INC., Denver, CO (US)

(72) Inventors: Anders Seline, New York, NY (US); Siddharth Srinivasan, New York, NY (US); Sherwood Martineau, New York, NY (US)

(21) Appl. No.: 19/215,592

(22) Filed: May 22, 2025

Related U.S. Application Data
(60) Provisional application No. 63/797,346, filed on Apr. 30, 2025.

(51) Int. Cl. G06F 40/137; G06F 16/332

(52) U.S. Cl. CPC G06F 40/137; G06F 16/3326

(57) ABSTRACT

In some examples, systems and methods for standard coding processes and/or guideline ingestion are provided. In some examples, the method includes receiving input data, the input data including unstructured text data; accessing a hierarchical data model representing a standard coding document, the standard coding document including a set of standard codes, the hierarchical data structure including one or more levels, each level of the one or more levels including one or more elements; generating a first prompt based on the input data, the first prompt including a request of relevant first-level elements of a plurality of first-level elements; providing the first prompt to a generative artificial intelligence (GenAI) model.

This application claims the benefit of U.S. Provisional Application No. 63/797,346, filed Apr. 30, 2025, which is incorporated by reference herein for all purposes.

### TECHNICAL FIELD

Certain embodiments of the present disclosure relate to standard coding processes to identify standard codes. More particularly, certain embodiments of the present disclosure relate to identifying standard codes by ingesting standard coding documents and/or guideline documents using artificial intelligence (AI) models (e.g., language models).

### BACKGROUND

In some examples, many organizations and industries utilize standard coding processes (e.g., medical coding process, task coding process, etc.). In certain examples, many organizations and industries need to comply with guidelines (e.g., regulations, rules, criteria, etc.) when identifying standard codes.

Hence, it is desirable to improve techniques for standard coding processes.

### SUMMARY

Certain embodiments of the present disclosure relate to standard coding processes to identify standard codes. More particularly, certain embodiments of the present disclosure relate to identifying standard codes by ingesting standard coding documents and/or guideline documents using artificial intelligence (AI) models (e.g., language models).

At least some aspects of the present disclosure are directed to a method for standard coding processes. In some examples, the method includes receiving input data, the input data including unstructured text data; accessing a hierarchical data model representing a standard coding document, the standard coding document including a set of standard codes, the hierarchical data structure including one or more levels, each level of the one or more levels including one or more elements; generating a first prompt based on the input data, the first prompt including a request of relevant first-level elements of a plurality of first-level elements, the plurality of first-level elements being of a first level of the one or more levels; providing the first prompt to a generative artificial intelligence (GenAI) model; receiving a first response from the GenAI model, the first response including an indication indicative of one or more identified first-level elements of the plurality of first-level elements; identifying one or more intermediate-level elements associated with the one or more identified first-level elements, each intermediate-level element of the one or more intermediate-level elements being a child element associated with at least one of the one or more identified first-level elements; generating a second prompt based at least in part on the one or more identified intermediate-level elements and the input data; providing the second prompt to the GenAI model; and receiving a second response from the GenAI model based on the hierarchical data model, the second response including one or more applicable standard codes in the set of standard codes. The method is performed using one or more processors.

At least some aspects of the present disclosure are directed to a system for standard coding processes. In some examples, the system includes one or more processors, and one or more memories storing instructions that, when executed by the one or more processors, cause the system to perform a set of operations. In some examples, the set of operations include: receiving input data, the input data including unstructured text data; accessing a hierarchical data model representing a standard coding document, the standard coding document including a set of standard codes, the hierarchical data structure including one or more levels, each level of the one or more levels including one or more elements; generating a first prompt based on the input data, the first prompt including a request of relevant first-level elements of a plurality of first-level elements, the plurality of first-level elements being of a first level of the one or more levels; providing the first prompt to a generative artificial intelligence (GenAI) model; receiving a first response from the GenAI model, the first response including an indication indicative of one or more identified first-level elements of the plurality of first-level elements; identifying one or more intermediate-level elements associated with the one or more identified first-level elements, each intermediate-level element of the one or more intermediate-level elements being a child element associated with at least one of the one or more identified first-level elements; generating a second prompt based at least in part on the one or more identified intermediate-level elements and the input data; providing the second prompt to the GenAI model; and receiving a second response from the GenAI model based on the hierarchical data model, the second response including one or more applicable standard codes in the set of standard codes.

At least some aspects of the present disclosure are directed to a non-transitory computer-readable storage medium having instructions for standard coding processes that, when executed by one or more processors, cause the one or more processors to perform operations comprising: receiving input data, the input data including unstructured text data; accessing a hierarchical data model representing a standard coding document, the standard coding document including a set of standard codes, the hierarchical data structure including one or more levels, each level of the one or more levels including one or more elements; generating a first prompt based on the input data, the first prompt including a request of relevant first-level elements of a plurality of first-level elements, the plurality of first-level elements being of a first level of the one or more levels; providing the first prompt to a generative artificial intelligence (GenAI) model; receiving a first response from the GenAI model, the first response including an indication indicative of one or more identified first-level elements of the plurality of first-level elements; identifying one or more intermediate-level elements associated with the one or more identified first-level elements, each intermediate-level element of the one or more intermediate-level elements being a child element associated with at least one of the one or more identified first-level elements; generating a second prompt based at least in part on the one or more identified intermediate-level elements and the input data; providing the second prompt to the GenAI model; and receiving a second response from the GenAI model based on the hierarchical data model, the second response including one or more applicable standard codes in the set of standard codes.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified diagram showing a method for a standard coding process according to certain embodiments of the present disclosure.

FIG. 2 is a simplified diagram showing a method for medical coding processes according to certain embodiments of the present disclosure.

FIG. 3 is an illustrative computing environment for standard coding processes according to certain embodiments of the present disclosure.

FIG. 4 illustrates an example hierarchical graph according to certain embodiments of the present disclosure.

FIG. 5 illustrates an example guideline section mapping according to certain embodiments of the present disclosure.

FIG. 6 is an illustrative example of an output dataset (e.g., a submission) according to certain embodiments of the present disclosure.

FIG. 7 is a simplified diagram showing a computing system for implementing a system for standard coding processes in accordance with at least one example set forth in the disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods often do not provide an efficient way for a standard coding process. For example, a conventional system often cannot identify a plurality of relevant standard codes for a situation. In some examples, the conventional system often cannot conduct a standard coding process by automatically or semi-automatically ingesting and using unstructured data. In certain examples, the conventional systems often cannot provide adequate support (e.g., evidence, etc.) for the standard coding process.

Various embodiments of the present disclosure can achieve benefits and/or improvement over conventional systems by a computing system using a hierarchical data structure and an artificial intelligence (AI) model to identify one or more standard codes. In some embodiments, a standard code is a predefined code that is defined in a standard coding document (e.g., ICD-10 (International Classification of Diseases, 10^{th} Revision), task code document, etc.). In certain embodiments, benefits include allowing an automatic coding process to ingest input data including unstructured data (e.g., natural language texts, etc.) with improved efficiency and accuracy. In some embodiments, the computing system can identify one or more pieces of supporting evidence to reduce and/or avoid hallucinations of AI models. Additional and/or alternative benefits should be recognized by those of ordinary skill in the art, at least in light of the teachings provided herein.

According to some embodiments, a coding system (e.g., a software application for coding, a software module for coding, a software system for coding, a software platform for coding, etc.) can automatically or semi-automatically identify one or more standard codes based on input data including unstructured data (e.g., natural language texts, images, patient notes, lab results, etc.) by ingesting a standard coding document and/or one or more guideline documents. The coding system may be configured to access structured data and/or unstructured data from one or more third-party systems, with any use of patient data occurring only after obtaining all necessary legal, regulatory, and/or patient approvals or permissions. In some embodiments, a coding system refers to a computing system that can ingest a standard coding document (e.g., ICD (International Classification of Diseases) 10 document, CPT (Current Procedural Terminology) codes document, task code document, etc.) and/or one or more guideline documents to identify one or more standard codes and/or one or more pieces of supporting evidence applicable to input data. In certain embodiments, the coding system generates and/or uses a hierarchical data model (e.g., a hierarchical data structure, a hierarchical graph, etc.) representing the standard coding document. In some embodiments, the coding system uses a hierarchical data model, also referred to as a hierarchical data structure, representing the standard coding document to identify the one or more standard codes. In certain embodiments, a hierarchical data model (e.g., a hierarchical data structure, a hierarchical graph, etc.) includes two or more levels, where each level includes one or more elements. In some embodiments, the two or more levels of the hierarchical data model include a leaf level.

According to certain embodiments, a coding system (e.g., a software module, a software system) can include, use, and/or access one or more computing models (e.g., one or more artificial intelligence (AI) models, one or more generative AI (GenAI) models, etc.), also referred to as coding models, for mapping unstructured data to existing data structures. In some embodiments, a model, also referred to as a computing model, includes a model to process data. A model includes, for example, an artificial intelligence (AI) model, a machine learning (ML) model, a deep learning (DL) model, an image processing model, an algorithm, a rule, other computing models, and/or a combination thereof. In certain embodiments, a GenAI (generative AI) coding model can map unstructured data to existing data structures.

In certain examples, a GenAI coding model can be trained using a large amount of training data (e.g., unstructured data, hierarchical data models, standard codes, etc.). In some embodiments, the GenAI coding model includes a generative AI (artificial intelligence) model that is trained using a large amount of training data (e.g., corpus). In certain embodiments, a generative AI (GenAI) model is a type of AI model that can be used to produce various types of content, such as text, images, videos, audio, 3D (three-dimensional) data, 3D models, and/or the like. In some embodiments, a language model or a large language model (LLM), which is a type of GenAI model, can generate content (e.g., text, audio, video, or other form, etc.).

In some embodiments, the coding system includes a GenAI coding model that can be a language model (LM) that may include an algorithm, rule, model, and/or other programmatic instructions that can predict the probability of a sequence of words or expressions (e.g., textual queries, summary, text strings, software code, etc.). In some embodiments, a language model may, given a starting text string (e.g., one or more words), predict the next word or expression in the sequence. In certain embodiments, a language model may calculate the probability of different word combinations and/or software code based on the patterns learned during training (e.g., based on a set of text data from books, articles, websites, audio files, software code, etc.).

In some embodiments, a language model may generate many combinations of one or more next words and/or expressions that are coherent and contextually relevant. In certain embodiments, a language model can be an artificial intelligence (AI) model that has been trained to understand, generate, and manipulate language (e.g., computing language expressions). In some embodiments, a language model can be useful for natural language processing, including receiving natural language prompts and providing natural language responses based on the text on which the model is trained. In certain embodiments, a language model may include an n-gram, exponential, positional, neural network, and/or other type of model. In some embodiments, a language model can be used to generate software code.

In certain embodiments, the GenAI coding system includes and/or uses a GenAI coding model that can include a large language model (LLM), which was trained on a large data set and has a large number of parameters (e.g., billions of parameters, trillions of parameters, etc.). In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pretrained Transformer 3 (GPT-3) model, a GPT 3.5-turbo model, a GPT-4 model, a GPT-4o model, a Claude model, a command-xlang model, a bidirectional encoder representations from transformers (BERT) model, a pathways language model (PaLM) 2, and/or the like.

In some examples, patients who are admitted into inpatient care need to meet medical necessity requirements, for example, requirements decided by the insurance payor, in order to receive any reimbursement for expenses accrued in the patient's care. As an example, a patient's chart (e.g., encounter notes, labs, medications administered, vital signs, etc.) can indicate signs of a severe condition that necessitates an inpatient stay, but the insurance company will require 1) the structured, admitting diagnoses (e.g., standard codes) applied to the patient by the provider (e.g., Dr. X); and 2) the evidence present in the patient's chart that supports the admitting diagnosis.

In certain examples, even if the patient chart shows a complete need for admission, an incorrect admitting diagnoses may result in the insurance payor denying the expense reimbursement entirely—regardless of future procedures or actions performed in the hospital. As an illustrative example of the problem, a patient suffers from a heart attack, but the provider inadvertently uses an admitting diagnosis of syncope (i.e., fainting). Despite the patient's severe state, the insurance company may deny the patient's request for reimbursement later due to the incorrect admitting diagnosis.

In some embodiments, the coding system can use a user-facing workflow and uses novel AI and/or GenAI techniques, both described further below. According to some embodiments, the coding system uses one or more large language models to determine one or more standard codes (e.g., applicable diagnoses, etc.). In certain embodiments, the coding system can leverage a hierarchical graph (e.g., a structured way) and/or one or more coding guidelines. In some embodiments, a coding guideline includes natural language textual information (e.g., a standard code having two or more requirements, etc.) related to a plurality of standard codes and/or a standard coding document. In certain embodiments, each level of the graph is evaluated in an incremental manner, for example, one level at a time. In some embodiments, the coding system uses the retrieval-augmented generation (RAG) technique to generate inputs to language models, which can generate more accurate and/or relevant outputs (e.g., responses). In certain embodiments, the coding system uses the Graph-RAG (retrieval-augmented generation using graph databases) technique to generate inputs to language models, which can generate more accurate and/or relevant outputs (e.g., responses). In some embodiments, the coding system can improve the accuracy of identified standard codes, using the techniques and/or embodiments described in the present disclosure. In certain embodiments, the coding system can use the Graph-RAG technique to improve the performance of GenAI techniques.

In some examples, the coding system ingests ICD10-CM medical codes, and traverses a hierarchical data model (e.g., a hierarchical graph, a hierarchical data structure) of these codes while referencing a patient's chart and additional more-detailed medical coding guidelines. In certain examples, ICD10-CM codes are organized into chapters, categories, and codes, and each code is roughly analogous to a diagnosis (sometimes a single diagnosis is comprised of many codes). In some examples, the coding system (e.g., using a GenAI model) evaluates a first-level element (e.g., a top-level element) of a first level in the hierarchical graph (e.g., a tree), determines its applicability with respect to the patient, and then continues to the second level that is the next level below the first level if the first-level element does apply. For example, a true evaluation of the chapter for respiratory conditions would unlock coding categories related to COPD (chronic obstructive pulmonary disease), respiratory failure, asthma, etc., each of which would further unlock codes that outline the specific condition more precisely (e.g., acute respiratory failure with hypoxia).

In some embodiments, depending on which areas of the hierarchical graph are traversed to, medical coding guidelines are added to prompt the GenAI model to explain exactly how to code certain diagnoses. For example, a true evaluation of respiratory failure would allow the system to refer to coding guidelines as to how to code for these kinds of diagnoses. In some examples, these coding guidelines can be general guidelines (e.g., guidelines of CMS (Centers for Medicare and Medicaid Services), etc.) described as to how a diagnosis should be evaluated, and/or provider (e.g., hospital, etc.) specific criteria which are manually defined. For example, the coding system can ingest one or more coding guideline sections to map to one or more coding categories. As an example, a coding guideline section can map to two or more coding categories.

According to certain embodiments, when the evaluation process takes place, the evaluation information for each element in the hierarchical graph are maintained to allow users to audit a model chain of thought. In some examples, some existing coding technologies do not utilize external information (e.g., coding guidelines, etc.), and have no prompting structure. As such, in certain embodiments, the coding system can improve the efficiency in using the GenAI model and reduce hallucinations of the GenAI model for the standard coding processes.

In some examples, the coding system is operationalized in a workflow for case managers, who are typically tasked with taking the provider diagnoses applied to the patient, and finding evidence for these in the patient chart subject to coding guidelines. In certain examples, the case managers are not empowered to try and improve documentation, but this coding system described in embodiments of the present disclosure would allow them to be.

In some examples, the coding system can be used with an authorized patient portal software that is used to collect and store patient data, including physician notes, viral signs, lab results, diagnosis images, and/or the like. While reviewing a patient chart within a patient portal software, the case managers can select the patient in the coding system to start a standard coding process. After the model has run, the case managers can review all recommended diagnoses (e.g., applicable standard codes, etc.), which contain specific justification and are linked to pieces of evidence (e.g., specific parts of notes, labs, medications, vital signs, etc.) that support the diagnosis. In some examples, the case managers can then validate each diagnosis (e.g., each standard code), and auto-generate a message including the diagnosis and the pieces of supporting evidence, for example, which can be sent to another system (e.g., a patient chart system to update the patient chart, an insurance system, etc.). In some embodiments, the coding system can fully automate the entire coding process.

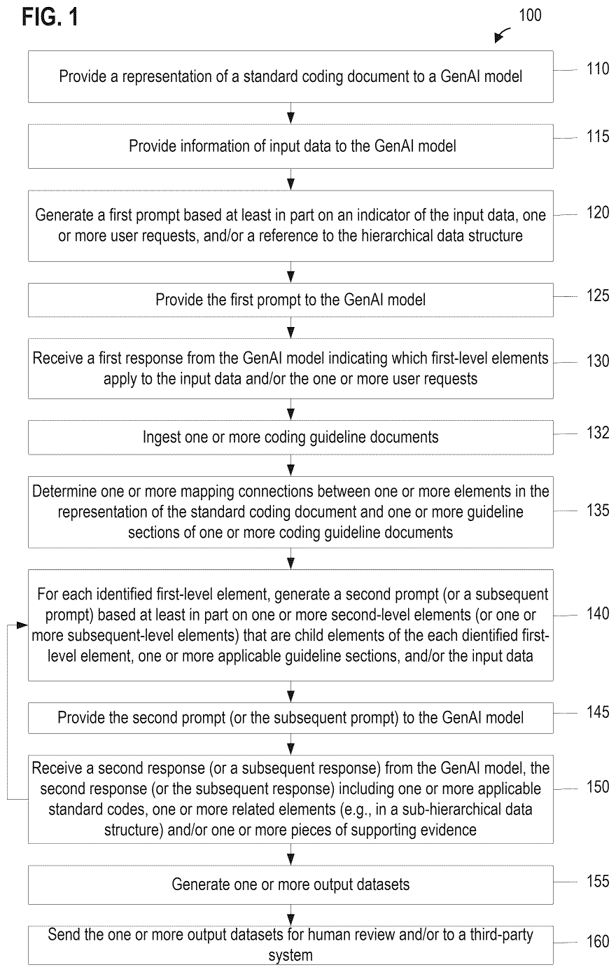

FIG. 1 is a simplified diagram showing a method 100 for a standard coding process according to certain embodiments of the present disclosure. This diagram is merely an example. One of ordinary skill in the art would recognize many variations, alternatives, and modifications. The method 100 includes processes 110-160. Although the above has been shown using a selected group of processes for the method 100, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

In some embodiments, some or all processes (e.g., steps) of the method 100 are performed by a system (e.g., the computing system 700). In certain examples, some or all processes (e.g., steps) of the method 100 are performed by a computer and/or a processor directed by a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

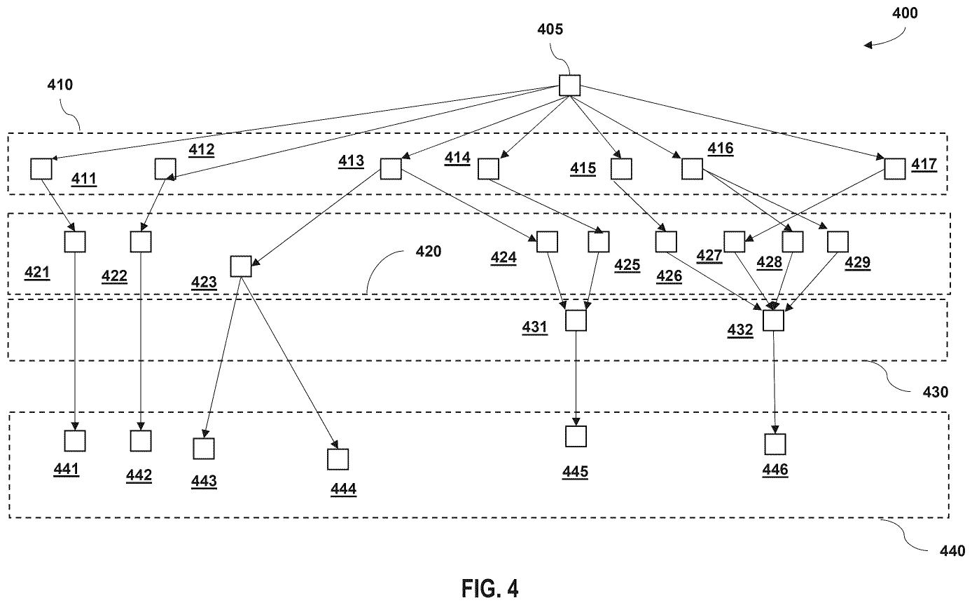

According to some embodiments, at process 110, the system provides a representation of a standard coding document (e.g., a task coding document, a medical coding document, etc.) to a GenAI model (e.g., an LLM). In certain embodiments, the GenAI model includes two or more GenAI models. In certain embodiments, the system generates the representation of the standard coding document. In some embodiments, the representation is a hierarchical data model, a hierarchical data architecture, a hierarchical graph (e.g., the hierarchical graph 400 illustrated in FIG. 4, etc.), and/or the like. In some examples, the system can ingest one or more standard coding documents (e.g., task coding documents, medical coding documents, etc.), for example, coding documents for how to apply standard codes (e.g., predefined codes, etc.). In certain embodiments, the system accesses, uses, and/or generates a hierarchical data model (e.g., a hierarchical data structure, a hierarchical graph, etc.) that represents a standard coding document. In some embodiments, the hierarchical data model includes a plurality of levels of elements. In certain embodiments, the hierarchical graph includes a first level, one or more intermediate levels, and a leaf level. In certain examples, the hierarchical data model includes a first level of elements being chapter elements (e.g., chapter J for diseases of the respiratory system, etc.), a second level or an intermediate level of elements being category elements (e.g., J44 for chronic obstructive pulmonary disease, etc.) and a leaf level (e.g., third level, fourth level, etc.) of elements being code elements (e.g., J44.0 and J44.1). In certain embodiments, a standard coding document includes a code description for each code, including, for example, a description that explains what the code represents. In some embodiments, a code description includes descriptions to help clarify the exact condition or circumstance a standard code is meant to capture. In certain embodiments, the code description includes specific notes and instructions, such as “excludes” or “includes” notes that direct how a standard code should be used.

FIG. 4 illustrates an example hierarchical graph 400 according to certain embodiments of the present disclosure. FIG. 4 is merely an example. One of ordinary skill in the art would recognize many variations, alternatives, and modifications. In the example illustrated, the hierarchical graph 400 includes a root element 405, a plurality of first-level elements 410 (e.g., first-level element 411, 412, 413, 414, 415, 416, 417, 418, etc.), a plurality of second-level elements 420 (e.g., second-level element 421, 422, 423, 424, 425, 426, 427, 428, 429 etc.), a plurality of third-level elements 430 (e.g., a third-level element 431, 432, etc.), and a plurality of leaf-level elements 440 (e.g., fourth-level element or leaf-level element 441, 442, 443, 444, 445, 446, etc.). In some examples, a parent element (e.g., second-level element 423) is a parent element of two or more child elements (e.g., leaf-level elements 443, 444). In certain examples, a child element (e.g., third-level elements 432) is a child element of two or more parent elements (e.g., second-level elements 426, 427, 428, 429, etc.). While there are five levels in this example, other embodiments may include more than five levels of elements or less than five levels of elements in a hierarchical graph. In some embodiments, an element in the hierarchical graph can be a data structure including one or more parent identifiers (IDs), one or more child IDs, an element name, an element description, one or more guideline section IDs, and/or the like. In certain embodiments, an element description includes one or more criteria associated with the element (e.g., pulmonary disease, etc.). In some embodiments, an element description includes one or more qualification criteria (e.g., what conditions to be included, etc.) and disqualification criteria (e.g., what conditions to be excluded, etc.). In certain examples, the hierarchical graph includes a top level of chapters, a next-top level of categories for each chapter, and one or more lower levels of codes for each category. In some embodiments, a standard code is associated with one or more criteria represented in an element description. In certain embodiments, a standard code is associated with two or more criteria represented in an element description.

According to certain embodiments, the system provides an indication (e.g., reference information, a software application name, etc.) of the hierarchical graph. In some embodiments, the system provides the standard coding document to the GenAI model to generate the hierarchical data structure (e.g., the hierarchical graph). In certain embodiments, the GenAI model can access the stored information of the hierarchical data structure representing the standard coding document (e.g., ICD-10-CM, etc.). In some embodiments, the GenAI model can access the stored information of the hierarchical data structure representing the standard coding document (e.g., ICD-10-CM, etc.) based on information in a prompt (e.g., a software application name, a link, an indication of a hierarchical data structure, etc.). In certain embodiments, a prompt includes one or more requests (e.g., one or more text requests, etc.) and/or context information.

According to some embodiments, at process 115, the system provides information of input data to the GenAI model (e.g., LLM), where the GenAI model uses and/or stores the received information of the input data. In certain examples, the input data includes structured data (e.g., table data, data records, etc.), unstructured data, text strings, images, and/or the like. In some examples, the input data includes data from two or more sources (e.g., data sources from two or more third-party systems, etc.). In certain embodiments, the input data includes structured data and/or unstructured data. In some embodiments, the input data includes unstructured data such as one or more natural language descriptions.

According to certain embodiments, at process 120, the system generates a first prompt to be provided to the GenAI model based at least in part on an indicator (e.g., a link, etc.) of the input data, one or more user requests (e.g., natural language requests received from a user, etc.), and/or a reference to the representation of the standard coding document (e.g., the hierarchical data model). In some examples, the first prompt includes one or more user requests (e.g., one or more input prompts received from a user, etc.) to the GenAI model to evaluate, for each chapter of the standard coding document, whether or not the chapter applies to the input data. In certain examples, the first prompt includes a portion of the input data and a reference to all the chapters in the standard coding document. In some examples, the portion of the input data includes a portion of the input data relevant to a keyword, for example, based on the one or more user requests. In certain examples, the portion of the input data does not include all of the input data.

According to some embodiments, at process 125, the system provides the first prompt to the GenAI model. In certain embodiments, the first prompt includes a text string. In some examples, the first prompt includes the input data, and/or a collection of the first-level elements in the hierarchical data model.

According to certain embodiments, at process 130, the system receives a first response from the GenAI model indicating which first-level elements, referred to as identified first-level elements, apply to the input data and/or the one or more user requests. In some embodiments, the first response includes one or more responses from the GenAI model, where the one or more responses indicate, for each chapter of the standard coding document, whether or not the chapter applies to the input data and/or the one or more user requests. For example, the one or more user requests include a request for a specific task and the first response includes one or more chapters in the standard coding document related to the specific task.

According to some embodiments, at process 132, the system ingests one or more coding guideline documents associated with the standard coding document. In certain embodiments, the system ingests the one or more guideline documents to generate one or more guideline sections. In certain examples, the system can ingest one or more coding guideline documents (e.g., a guideline document providing how to code different tasks, etc.).

According to certain embodiments, at process 135, the system determines one or more mapping connections between one or more elements in the representation of the standard coding document and one or more guideline sections of the one or more coding guideline documents. In some embodiments, the system generates a connection map between one or more guideline sections in a coding guideline document and one or more elements in the hierarchical data model (e.g., the hierarchical data structure, the hierarchical graph, etc.). In some embodiments, the system generates a mapping connection between each guideline section in a coding guideline document and one or more elements in the hierarchical graph. For example, a guideline section is mapped to one or more first-level elements (e.g., chapter elements, etc.), one or more second-level elements (e.g., category elements, etc.), one or more third-level elements (e.g., category elements, etc.), one or more leaf-level elements (e.g., code elements, etc.), and/or the like.

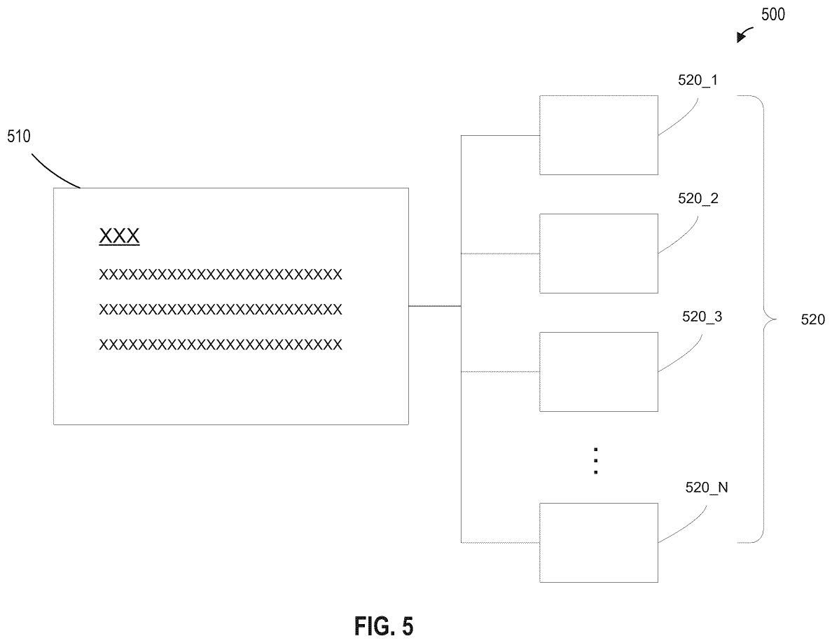

FIG. 5 illustrates an example guideline section mapping 500 according to certain embodiments of the present disclosure. FIG. 5 is merely an example. One of ordinary skill in the art would recognize many variations, alternatives, and modifications. In the example illustrated, a guideline section 510 is mapped to one or more elements 520 (e.g., element 520_1, 520_2, 520_3, . . . 520_N), by one or more mapping connections. In some examples, the guideline section 510 is mapped to elements from different levels. For example, the element 520_1 is a first-level element in a hierarchical graph, the element 520_2 is a second-level element in the hierarchical graph. As another example, the element 520_3 is a leaf-level element in a hierarchical graph, the element 520_N is a second-level element in the hierarchical graph. In certain embodiments, a guideline section 510 can include a data structure including the section name, the section data (e.g., guideline text, etc.), one or more mapping connections to one or more elements in a hierarchical data model, and/or the like. For example, the guideline section 510 describes how to code coexisting criteria such as a first criterion and a second criterion. In some embodiments, a standard code is associated with one or more criteria represented in a guideline section and/or an element description. In certain embodiments, a standard code is associated with two or more criteria represented in a guideline section and/or an element description.

According to some embodiments, at process 140, for each identified first-level element of the one or more first-level elements identified in the first response, the system generates a second prompt (or a subsequent prompt, e.g., a third prompt, a fourth prompt, etc.) based at least in part on at least one of one or more second-level elements (or one or more intermediate-level elements, e.g., third-level elements, fourth-level elements, etc.), also referred to as one or more intermediate-level elements that are child elements associated with (e.g., child elements, grandchild elements, etc.) the each identified first-level element, one or more applicable guideline sections, and/or at least a part of the input data. In certain embodiments, the system identifies at least a part of one or more applicable guideline sections based at least in part on the each identified first-level element and one or more mapping connections. In some embodiments, the system identifies at least a part of the one or more applicable guideline sections based at least in part on the one or more second-level elements that are child elements of the each identified first-level element and one or more mapping connections (e.g., one or more mapping connections in a respective element data structure, one or more mapping connections in a respective guideline section data structure, etc.). In certain embodiments, when an intermediate-level element is not associated with any guideline section, the system generates the second prompt and/or the subsequent prompt based at least in part on the element description of the intermediate-level element and/or one or more element descriptions of one or more child elements of the intermediate-level element.

According to certain embodiments, at process 145, the system provides the second prompt (or a subsequent prompt) to the GenAI model. In some embodiments, the GenAI model includes two or more GenAI models. In certain embodiments, for each identified first-level element (e.g., a chapter element in the hierarchical graph of the standard coding document) of the one or more identified first-level elements, the second prompt includes a prompt request of a traversal of a sub-hierarchical data structure corresponding to the each identified first-level element to identify one or more child elements of the each identified first-level element and/or one or more applicable standard codes. In some embodiments, the system, using the GenAI model, evaluates each second-level element (e.g., each category element) of the first-level element (e.g., the chapter element) and determines whether or not the second-level element applies to the input data. In certain embodiments, the system iteratively evaluates child elements in the sub-hierarchical data structure one level at a time until it reaches the leaf level. In some embodiments, the system receives a sub-hierarchical data structure corresponding to an element where each child element in the sub-hierarchical data structure includes an indication of whether each child element is applicable to the input data, which provides a model chain of thought.

According to some embodiments, at process 150, the system receives a second response (or a subsequent response) from the GenAI model, the second response (or the subsequent response) including one or more applicable standard codes, one or more related elements (e.g., in a hierarchical structure) and/or one or more pieces of supporting evidence. In some examples, the system receives one or more responses from the GenAI model, wherein the one or more responses indicate, for an applicable chapter of the standard coding document, with respect to each category of the chapter, whether or not the category applies to the input data. In certain examples, if a category of a chapter has been determined by the GenAI model to apply to the input data, the system determines whether or not this applicable category is related to any coding guideline sections and/or any coding guideline documents associated with the standard coding document. In some examples, if this applicable category is determined to be related to one or more guideline sections, for each related guideline section, the system includes the content of this related guideline section in a prompt (e.g., the second prompt, a subsequent prompt, etc.) to the GenAI model. In some embodiments, the system repeats processes 140-150 until a leaf level is reached for each identified first-level element.

According to certain embodiments, the content of the guideline section includes an applicable element and one or more additional elements. In some embodiments, the one or more additional elements are not child elements of the identified first-level elements. In certain embodiments, the system generates a subsequent prompt based on the element data (e.g., element description, etc.) of at least one of the one or more additional elements. In some examples, the one or more additional elements includes an additional first-level element. In certain examples, the system traverses a sub-hierarchical data structure corresponding to the additional first-level element (e.g., a chapter element) to identify one or more additional standard codes and/or one or more additional pieces of supporting evidence. In some examples, the one or more additional elements include an additional second-level element and/or an additional intermediate-level element. In certain examples, the system, using the GenAI model, evaluates the additional second-level element (e.g., an additional category element, etc.) and/or the additional intermediate-level element and corresponding child elements to identify one or more additional standard codes and/or one or more additional pieces of supporting evidence. In some examples, the one or more additional standard codes overlap with the one or more standard codes identified based on the one or more identified first-level elements (e.g., indicated in the first response, etc.).

According to some embodiments, the system provides one or more subsequent prompts to the GenAI model. In certain embodiments, the system provides a subsequent prompt to determine whether the one or more additional elements (e.g., additional categories) are applicable to the input data. In some embodiments, for each category that has been determined to be applicable, the system determines which standard code(s) of the category applies to the input data. In some embodiments, the system generates one or more output datasets (e.g., applicable standard codes, etc.), for example, receiving from the GenAI model, for the input data. In certain embodiments, the system generates the one or more output datasets that include one or more applicable codes and one or more pieces of supporting evidence extracted from the input data.

According to certain embodiments, at process 155, the system generates one or more output datasets. In some embodiments, the system identifies one or more guideline sections related to the one or more identified first-level elements and/or one or more child elements of the one or more identified first-level elements. In certain embodiments, the system generates a prompt for each related guideline section to identify one or more standard codes and/or one or more pieces of supporting evidence. In some embodiments, the system generates two or more prompts for two or more related guideline sections to identify one or more standard codes and/or one or more pieces of supporting evidence. In certain embodiments, the one or more output datasets include the one or more standard codes, the one or more related elements in the sub-hierarchical data structure (e.g., each element indicating applicable or not, etc.) and/or the one or more pieces of supporting evidence. In some embodiments, at least one of the one or more pieces of supporting evidence is extracted from the input data. In certain embodiments, at least one of the one or more pieces of supporting evidence is extracted from a coding guideline section and/or a coding guideline document. In some embodiments, at least one of the one or more pieces of supporting evidence is extracted from an element description of an element in the hierarchical data model.

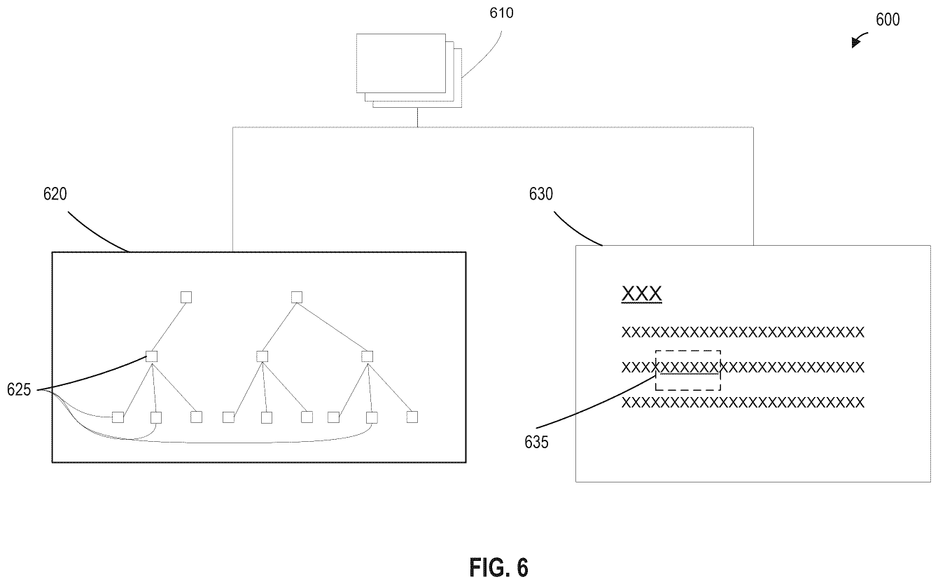

FIG. 6 is an illustrative example of an output dataset 600 (e.g., a submission) according to certain embodiments of the present disclosure. FIG. 6 is merely an example. One of ordinary skill in the art would recognize many variations, alternatives, and modifications. In the example illustrated, the output dataset 600 includes one or more standard codes 610, one or more sub-hierarchical data structures 620, and one or more pieces of supporting evidence 630. In some embodiments, the sub-hierarchical data structure 620 is a subset of the hierarchical data model representing the standard coding document. In certain embodiments, each element 625 in the sub-hierarchical data structure 620 has an indication of whether the element 625 is applicable to the input data, which a model chain of thought. In some embodiments, a piece of supporting evidence 630 includes one or more highlighted sections 635.

According to certain embodiments, when the coding process takes place, the evaluation information for each element in relevant part of the hierarchical data model are maintained to allow users to review and/or audit a model chain of thought. In some examples, some existing coding technologies do not utilize external information (e.g., coding guidelines, etc.), and have no prompting structure. As such, in certain embodiments, the coding system can improve the efficiency in using the GenAI model and reduce hallucinations of the GenAI model for the standard coding processes.

According to some embodiments, at process 160, the system sends the one or more output datasets for human review (e.g., reviewed by case managers, etc.) and/or to a third-party system (e.g., a client system). In certain examples, the human reviewer can modify the one or more output datasets to generate one or more revised output datasets to send to the third-party system and/or a software module of the coding system. In some examples, the human reviewer can modify the one or more output datasets to generate one or more revised output datasets to send a subsequent human review (e.g., by a supervisor, etc.).

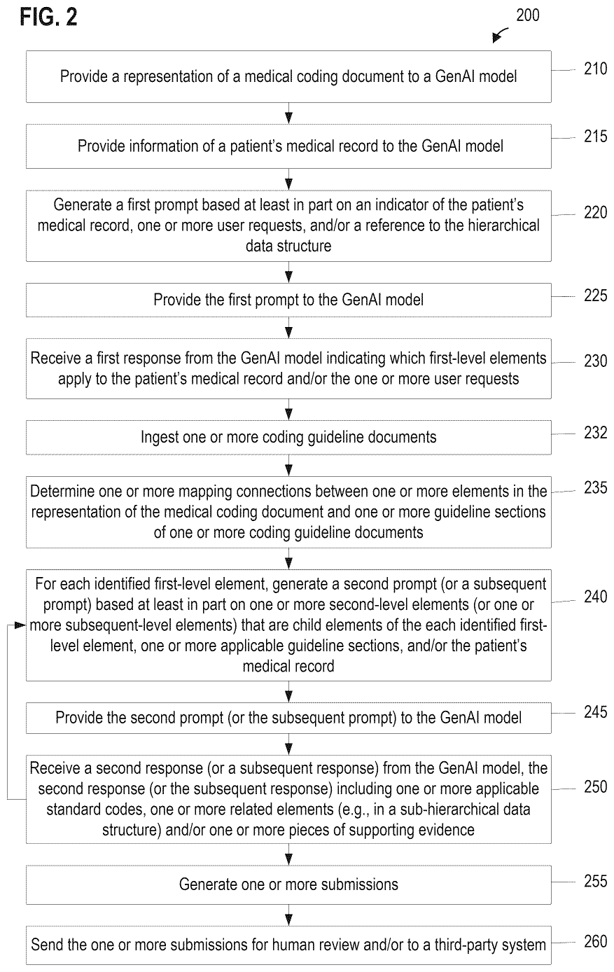

FIG. 2 is a simplified diagram showing a method 200 for medical coding processes according to certain embodiments of the present disclosure. This diagram is merely an example. One of ordinary skill in the art would recognize many variations, alternatives, and modifications. The method 200 includes processes 210-260. Although the above has been shown using a selected group of processes for the method 200, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

In some embodiments, some or all processes (e.g., steps) of the method 200 are performed by a system (e.g., the computing system 700). In certain examples, some or all processes (e.g., steps) of the method 200 are performed by a computer and/or a processor directed by a code. For example, a computer includes a server computer and/or a client computer (e.g., a personal computer). In some examples, some or all processes (e.g., steps) of the method 200 are performed according to instructions included by a non-transitory computer-readable medium (e.g., in a computer program product, such as a computer-readable flash drive). For example, a non-transitory computer-readable medium is readable by a computer, including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at process 210, the system provides a representation of a medical coding document (e.g., ICD-10-CM) to a GenAI model (e.g., an LLM). In certain embodiments, the system generates the representation of the medical coding document. In some embodiments, the representation is a hierarchical data model, a hierarchical data architecture, a hierarchical graph (e.g., the hierarchical graph 400 illustrated in FIG. 4, etc.), and/or the like. In some examples, the system can ingest ICD-10-CM and/or other medical coding documents (e.g., CPT, etc.), for example, coding documents for medical diagnosis coding. In certain embodiments, the system accesses, uses, and/or generates a hierarchical graph that represents a medical coding document. In some embodiments, the hierarchical graph includes a plurality of levels of elements. In certain examples, the hierarchical graph includes a first level of elements being chapter elements (e.g., chapter J for diseases of the respiratory system, etc.), a second level or an intermediate level of elements being category elements (e.g., J44 for chronic obstructive pulmonary disease, etc.) and a leaf level (e.g., third level, fourth level, etc.) of elements being code elements (e.g., J44.0 and J44.1). In certain embodiments, a medical coding document includes a code description for each code, including, for example, a description that explains what the code represents. In some embodiments, a code description includes descriptions to help clarify the exact condition or circumstance a standard code is meant to capture. In certain embodiments, the code description includes specific notes and instructions, such as “excludes” or “includes” notes that direct how a standard code should be used.

FIG. 4 illustrates an example hierarchical graph 400 according to certain embodiments of the present disclosure. FIG. 4 is merely an example. One of ordinary skill in the art would recognize many variations, alternatives, and modifications. In the example illustrated, the hierarchical graph 400 includes a root element 405, a plurality of first-level elements 410 (e.g., first-level element 411, 412, 413, 414, 415, 416, 417, 418, etc.), a plurality of second-level elements 420 (e.g., second-level element 421, 422, 423, 424, 425, 426, 427, 428, 429 etc.), a plurality of third-level elements 430 (e.g., a third-level element 431, 432, etc.), and a plurality of leaf-level elements 440 (e.g., fourth-level element or leaf-level element 441, 442, 443, 444, 445, 446, etc.). In some examples, a parent element (e.g., second-level element 423) is a parent element of two or more child elements (e.g., leaf-level elements 443, 444). In certain examples, a child element (e.g., third-level elements 432) is a child element of two or more parent elements (e.g., second-level elements 426, 427, 428, 429, etc.). While there are five levels in this example, other embodiments may include more than five levels of elements or less than five levels of elements in a hierarchical graph. In some embodiments, an element in the hierarchical graph can be a data structure including one or more parent identifiers (IDs), one or more child IDs, an element name, an element description, one or more guideline section IDs, and/or the like. In certain embodiments, an element description includes one or more criteria associated with the element (e.g., pulmonary disease, etc.). In some embodiments, an element description includes one or more qualification criteria (e.g., what conditions to be included, etc.) and disqualification criteria (e.g., what conditions to be excluded, etc.). In certain examples, the hierarchical graph includes a top level of chapters, a next-top level of categories for each chapter, and one or more lower levels of codes for each category.

According to certain embodiments, the system provides an indication (e.g., reference information, a software application name, etc.) of the hierarchical graph. In some embodiments, the system provides the standard coding document to the GenAI model to generate the hierarchical data structure (e.g., the hierarchical graph). In certain embodiments, the GenAI model can access the stored information of the hierarchical data structure representing the medical coding document (e.g., ICD-10-CM, etc.). In some embodiments, the GenAI model can access the stored information of the hierarchical data structure representing the medical coding document (e.g., ICD-10-CM, etc.) based on information in a prompt (e.g., a software application name, a link, an indication of a hierarchical data structure, etc.). In certain embodiments, a prompt includes one or more requests (e.g., one or more text requests, etc.) and/or context information.

According to some embodiments, at process 215, the system provides information of a patient's medical record to the GenAI model (e.g., LLM), where the GenAI model uses and/or stores the received information of the patient's medical record, with any use of patient data occurring only after obtaining all necessary legal, regulatory, and/or patient approvals or permissions. In certain examples, a patient's medical record includes one or more patient encounter notes, one or more lab results, and/or the like. In some examples, the patient's medical record includes data from two or more sources (e.g., a patient portal software, a hospital record, etc.). In certain embodiments, the patient's medical record includes structured data and/or unstructured data. In some embodiments, the patient's medical record includes unstructured data such as one or more patient encounter notes.

According to certain embodiments, at process 220, the system generates a first prompt to be provided to the GenAI model based at least in part on an indicator (e.g., a link, etc.) of the patient's medical record, one or more user requests (e.g., natural language requests received from a user, etc.), and/or a reference to the representation of the medical coding document (e.g., the hierarchical data model). In some examples, the first prompt includes one or more user requests (e.g., one or more input prompts received from a user, etc.) to the GenAI model to evaluate, for each chapter of the medical coding document, whether or not the chapter applies to the patient's medical record. In certain examples, the first prompt includes a portion of the patient's medical record and a reference to all the chapters in the standard coding document. In some examples, the portion of the patient's medical record includes a portion of the patient's medical record relevant to a symptom and/or a diagnosis (e.g., a previous diagnosis), for example, based on the one or more user requests. In certain examples, the portion of the patient's medical record does not include all of the patient's medical record.

According to some embodiments, at process 225, the system provides the first prompt to the GenAI model. In certain embodiments, the first prompt includes a text string. In some examples, the first prompt includes a patient identifier (ID), the patient's medical record, and/or a collection of the chapters in the medical coding document.

According to certain embodiments, at process 230, the system receives a first response from the GenAI model indicating which first-level elements, referred to as identified first-level elements, apply to the patient's medical record and/or the one or more user requests. In some embodiments, the first response includes one or more responses from the GenAI model, where the one or more responses indicate, for each chapter of the medical coding document, whether or not the chapter applies to the patient's medical record and/or the one or more user requests. For example, the one or more user requests include a request for a pulmonary disease and the first response includes one or more chapters in the medical coding document related to a pulmonary disease.

According to some embodiments, at process 232, the system ingests one or more coding guideline documents. In certain embodiments, the system ingests the one or more guideline documents to generate one or more guideline sections. In certain examples, the system can ingest one or more medical coding guidelines (e.g., ICD-10-CM Official Guidelines for Coding and Reporting published by CMS, etc.).

According to certain embodiments, at process 235, the system determines one or more mapping connections between one or more elements in the representation of the medical coding document and one or more guideline sections of the one or more coding guideline documents. In some embodiments, the system generates a connection map between one or more guideline sections in a coding guideline document and one or more elements in the hierarchical data model (e.g., the hierarchical data structure, the hierarchical graph, etc.). In some embodiments, the system generates a mapping connection between each guideline section in a guideline document and one or more elements in the hierarchical graph. For example, a guideline section is mapped to one or more first-level elements (e.g., chapter elements, etc.), one or more second-level elements (e.g., category elements, etc.), one or more third-level elements (e.g., category elements, etc.), one or more leaf-level elements (e.g., code elements, etc.), and/or the like.

FIG. 5 illustrates an example guideline section mapping 500 according to certain embodiments of the present disclosure. FIG. 5 is merely an example. One of ordinary skill in the art would recognize many variations, alternatives, and modifications. In the example illustrated, a guideline section 510 is mapped to one or more elements 520 (e.g., element 520_1, 520_2, 520_3, . . . 520_N), by one or more mapping connections. In some examples, the guideline section 510 is mapped to elements from different levels. For example, the element 520_1 is a first-level element in a hierarchical graph, the element 520_2 is a second-level element in the hierarchical graph. As another example, the element 520_3 is a leaf-level element in a hierarchical graph, the element 520_N is a second-level element in the hierarchical graph. In certain embodiments, a guideline section 510 can include a data structure including the section name, the section data (e.g., guideline text, etc.), one or more mapping connections to one or more elements in a hierarchical data model, and/or the like. For example, the guideline section 510 describes how to code coexisting conditions such as chronic obstructive pulmonary disease (COPD) and asthma and specifically describes how to code the COPD (e.g., J44) and asthma (e.g., J45) categories together.

According to some embodiments, at process 240, for each identified first-level element of the one or more first-level elements identified in the first response, the system generates a second prompt (or a subsequent prompt, e.g., a third prompt, a fourth prompt, etc.) based at least in part on at least one of one or more second-level elements (or one or more intermediate-level elements, e.g., third-level elements, fourth-level elements, etc.) that are child elements of the each identified first-level element, one or more applicable guideline sections, and/or at least a part of the patient's medical record. In certain embodiments, the system identifies at least a part of one or more applicable guideline sections based at least in part on the each identified first-level element and one or more mapping connections. In some embodiments, the system identifies at least a part of the one or more applicable guideline sections based at least in part on the one or more second-level elements that are child elements of the each identified first-level element and one or more mapping connections (e.g., one or more mapping connections in a respective element data structure, one or more mapping connections in a respective guideline section data structure, etc.). In certain embodiments, when an intermediate-level element is not associated with any guideline section, the system generates the second prompt and/or the subsequent prompt based at least in part on the element description of the intermediate-level element and/or one or more element descriptions of one or more child elements of the intermediate-level element.

According to certain embodiments, at process 245, the system provides the second prompt (or a subsequent prompt) to the GenAI model. In some embodiments, the GenAI model includes two or more GenAI models. In certain embodiments, for each identified first-level element (e.g., a chapter element in the hierarchical graph of the medical coding document) of the one or more identified first-level elements, the second prompt includes a prompt request of a traversal of a sub-hierarchical data structure corresponding to the each identified first-level element to identify one or more child elements of the each identified first-level element and/or one or more applicable standard codes. In some embodiments, the system, using the GenAI model, evaluates each second-level element (e.g., each category element) of the first-level element (e.g., the chapter element) and determines whether or not the second-level element applies to the patient's medical record. In certain embodiments, the system iteratively evaluates child elements in the sub-hierarchical data structure one level at a time until it reaches the leaf level. In some embodiments, the system receives a sub-hierarchical data structure corresponding to an element where each child element in the sub-hierarchical data structure includes an indication of whether each child element is applicable to the patient's medical record, which is a model chain of thought.

According to some embodiments, at process 250, the system receives a second response (or a subsequent response) from the GenAI model, the second response (or the subsequent response) including one or more applicable standard codes, one or more related elements (e.g., in a hierarchical structure) and/or one or more pieces of supporting evidence. In some examples, the system receives one or more responses from the GenAI model, wherein the one or more responses indicate, for an applicable chapter of the medical coding document, with respect to each category of the chapter, whether or not the category applies to the patient's medical record. In certain examples, if a category of a chapter has been determined by the GenAI model to apply to the patient's medical record, the system determines whether or not this applicable category is related to any coding guideline sections and/or any coding guideline documents associated with the medical coding document. In some examples, if this applicable category is determined to be related to one or more guideline sections, for each related guideline section, the system includes the content of this related guideline section in a prompt (e.g., the second prompt, a subsequent prompt, etc.) to the GenAI model. In some embodiments, the system repeats processes 240-250 until a leaf level is reached for each identified first-level element.

According to certain embodiments, the content of the guideline section includes an applicable element and one or more additional elements. In some embodiments, the one or more additional elements are not child elements of the identified first-level elements. In certain embodiments, the system generates a subsequent prompt based on the element data (e.g., the element description, etc.) of at least one of the one or more additional elements. In some examples, the one or more additional elements includes an additional first-level element. In certain examples, the system traverses a sub-hierarchical data structure corresponding to the additional first-level element (e.g., a chapter element) to identify one or more additional standard codes and/or one or more additional pieces of supporting evidence. In some examples, the one or more additional elements include an additional second-level element and/or an additional intermediate-level element. In certain examples, the system, using the GenAI model, evaluates the additional second-level element (e.g., an additional category element, etc.) and/or the additional intermediate-level element and corresponding child elements to identify one or more additional standard codes and/or one or more additional pieces of supporting evidence. In some examples, the one or more additional standard codes overlap with the one or more standard codes identified based on the one or more identified first-level elements (e.g., indicated in the first response, etc.).

According to some embodiments, the system provides one or more subsequent prompts to the GenAI model. In certain embodiments, the system provides a subsequent prompt to determine whether the one or more additional elements (e.g., additional categories) are applicable to the patient's medical record. In some embodiments, for each category that has been determined to be applicable, the system determines which standard code(s) of the category applies to the patient's medical record. In some embodiments, the system generates one or more admitting diagnoses (e.g., applicable standard codes, etc.), for example, receiving from the GenAI model, for the patient. In certain embodiments, the system generates one or more the one or more admitting diagnoses that include one or more applicable codes and one or more pieces of supporting evidence extracted from the patient's medical record.

According to certain embodiments, at process 255, the system generates one or more submissions. In some embodiments, the system identifies one or more guideline sections related to the one or more identified first-level elements and/or one or more child elements of the one or more identified first-level elements. In certain embodiments, the system generates a prompt for each related guideline section to identify one or more standard codes and/or one or more pieces of supporting evidence. In some embodiments, the system generates two or more prompts for two or more related guideline sections to identify one or more standard codes and/or one or more pieces of supporting evidence. In certain embodiments, the one or more submissions include the one or more standard codes, the one or more related elements in the sub-hierarchical data structure (e.g., each element indicating applicable or not, etc.) and/or the one or more pieces of supporting evidence. In some embodiments, at least one of the one or more pieces of supporting evidence is extracted from the patient's medical record. In certain embodiments, at least one of the one or more pieces of supporting evidence is extracted from a coding guideline section and/or a coding guideline document. In some embodiments, at least one of the one or more pieces of supporting evidence is extracted from an element description of an element in the hierarchical data model.

FIG. 6 is an illustrative example of an output dataset (e.g., submission) 600 according to certain embodiments of the present disclosure. FIG. 6 is merely an example. One of ordinary skill in the art would recognize many variations, alternatives, and modifications. In the example illustrated, the output dataset 600 includes one or more standard codes 610, one or more sub-hierarchical data structures 620, and one or more pieces of supporting evidence 630. In some embodiments, the sub-hierarchical data structure 620 is a subset of the hierarchical data model representing the medical coding document. In certain embodiments, each element 625 in the sub-hierarchical data structure 620 has an indication of whether the element 625 is applicable to the patient's medical record. In some embodiments, a piece of supporting evidence 630 includes one or more highlighted sections 635.

As an example, the output dataset 600 includes a standard code 610 (e.g., J44.1—chronic obstructive pulmonary disease (COPD) with acute exacerbation, etc.) and a piece of supporting evidence (e.g., “complaint: shortness of breath and wheezing,” etc.). As an example, the output dataset 600 includes a standard code 610 (e.g., I21.4—Non-ST elevation myocardial infarction (NSTEMI), etc.) and a piece of supporting evidence (e.g., “complaint: chest pain and dizziness,” etc.).

According to some embodiments, at process 260, the system sends the one or more submissions for human review (e.g., reviewed by case managers, etc.) and/or to a third-party system (e.g., an insurance system). In certain examples, the human reviewer can modify the one or more submissions to generate one or more revised submissions to send to the third-party system and/or a software module of the coding system. In some examples, the human reviewer can modify the one or more submissions to generate one or more revised submissions to send a subsequent human review (e.g., by a medical provider, by a doctor, etc.).

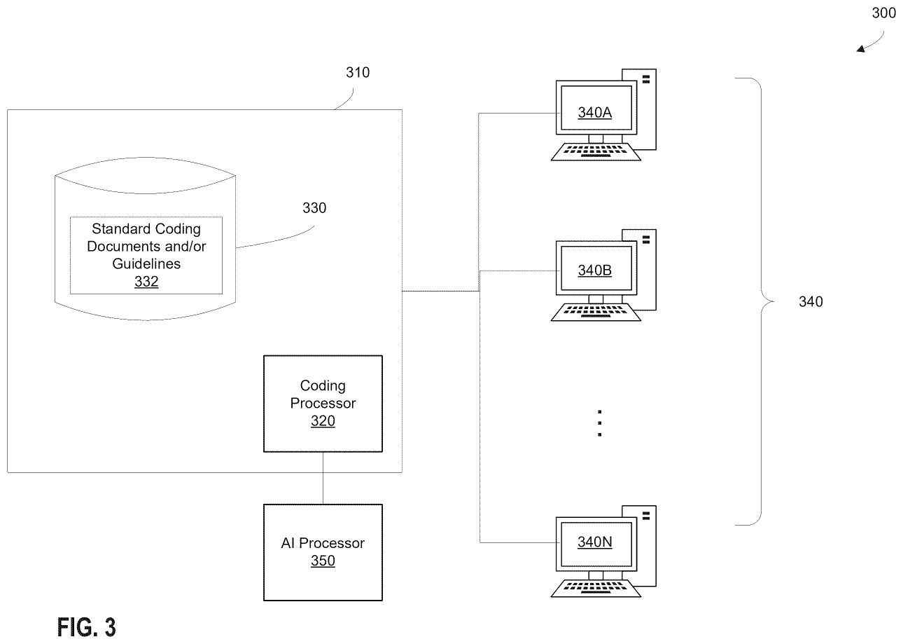

FIG. 3 is an illustrative computing environment 300 for standard coding processes according to certain embodiments of the present disclosure. FIG. 3 is merely an example. One of ordinary skill in the art would recognize many variations, alternatives, and modifications. In some embodiments, the computing environment 300 includes one or more coding systems 310 and one or more computing devices 340 (e.g., a user device 340A, a user device 340B, . . . a user device 340N, etc.). In certain embodiments, the coding system 310 includes one or more coding processors 320 and one or more data repositories 330. In some embodiments, the computing environment 300 includes one or more AI processors 350 running one or more GenAI models, such as one or more GenAI coding models.

According to some embodiments, the coding system 310 and/or the coding processor 320 provides a representation of a standard coding document (e.g., a task coding document, a medical coding document, etc.) to a GenAI model (e.g., an LLM), for example, a GenAI model hosted on the AI processor 350. In certain embodiments, the GenAI model includes two or more GenAI models. In certain embodiments, the coding system 310 and/or the coding processor 320 generates the representation of the standard coding document. In some embodiments, the representation is a hierarchical data model, a hierarchical data architecture, a hierarchical graph (e.g., the hierarchical graph 400 illustrated in FIG. 4, etc.), and/or the like. In some examples, the coding system 310 and/or the coding processor 320 can ingest one or more standard coding documents (e.g., task coding documents, medical coding documents, etc.), for example, coding documents for how to apply standard codes (e.g., predefined codes, etc.). In certain embodiments, the coding system 310 and/or the coding processor 320 accesses, uses, and/or generates a hierarchical data model (e.g., a hierarchical data structure, a hierarchical graph, etc.) that represents a standard coding document. In some embodiments, the hierarchical data model includes a plurality of levels of elements. In certain embodiments, the hierarchical graph includes a first level, one or more intermediate levels, and a leaf level. In certain examples, the hierarchical data model includes a first level of elements being chapter elements (e.g., chapter J for diseases of the respiratory system, etc.), a second level or an intermediate level of elements being category elements (e.g., J44 for chronic obstructive pulmonary disease, etc.) and a leaf level (e.g., third level, fourth level, etc.) of elements being code elements (e.g., J44.0 and J44.1). In certain embodiments, a standard coding document includes a code description for each code, including, for example, a description that explains what the code represents. In some embodiments, a code description includes descriptions to help clarify the exact condition or circumstance a standard code is meant to capture. In certain embodiments, the code description includes specific notes and instructions, such as “excludes” or “includes” notes that direct how a standard code should be used.

FIG. 4 illustrates an example hierarchical graph 400 according to certain embodiments of the present disclosure. FIG. 4 is merely an example. One of ordinary skill in the art would recognize many variations, alternatives, and modifications. In the example illustrated, the hierarchical graph 400 includes a root element 405, a plurality of first-level elements 410 (e.g., first-level element 411, 412, 413, 414, 415, 416, 417, 418, etc.), a plurality of second-level elements 420 (e.g., second-level element 421, 422, 423, 424, 425, 426, 427, 428, 429 etc.), a plurality of third-level elements 430 (e.g., a third-level element 431, 432, etc.), and a plurality of leaf-level elements 440 (e.g., fourth-level element or leaf-level element 441, 442, 443, 444, 445, 446, etc.). In some examples, a parent element (e.g., second-level element 423) is a parent element of two or more child elements (e.g., leaf-level elements 443, 444). In certain examples, a child element (e.g., third-level elements 432) is a child element of two or more parent elements (e.g., second-level elements 426, 427, 428, 429, etc.). While there are five levels in this example, other embodiments may include more than five levels of elements or less than five levels of elements in a hierarchical graph. In some embodiments, an element in the hierarchical graph can be a data structure including one or more parent identifiers (IDs), one or more child IDs, an element name, an element description, one or more guideline section IDs, and/or the like. In certain embodiments, an element description includes one or more criteria associated with the element (e.g., pulmonary disease, etc.). In some embodiments, an element description includes one or more qualification criteria (e.g., what conditions to be included, etc.) and disqualification criteria (e.g., what conditions to be excluded, etc.). In certain examples, the hierarchical graph includes a top level of chapters, a next-top level of categories for each chapter, and one or more lower levels of codes for each category. In some embodiments, a standard code is associated with one or more criteria represented in an element description. In certain embodiments, a standard code is associated with two or more criteria represented in an element description.

According to certain embodiments, the coding system 310 and/or the coding processor 320 provides an indication (e.g., reference information, a software application name, etc.) of the hierarchical graph. In some embodiments, the coding system 310 and/or the coding processor 320 provides the standard coding document to the GenAI model to generate the hierarchical data structure (e.g., the hierarchical graph). In certain embodiments, the GenAI model can access the stored information of the hierarchical data structure representing the standard coding document. In some embodiments, the GenAI model can access the stored information of the hierarchical data structure representing the standard coding document based on information in a prompt (e.g., a software application name, a link, an indication of a hierarchical data structure, etc.). In certain embodiments, a prompt includes one or more requests (e.g., one or more text requests, etc.) and/or context information.

According to some embodiments, the coding system 310 and/or the coding processor 320 provides information of input data to the GenAI model (e.g., LLM), where the GenAI model uses and/or stores the received information of the input data. In certain examples, the input data includes structured data (e.g., table data, data records, etc.), unstructured data, text strings, images, and/or the like. In some examples, the input data includes data from two or more sources (e.g., data sources from two or more third-party systems, etc.). In certain embodiments, the input data includes structured data and/or unstructured data. In some embodiments, the input data includes unstructured data such as one or more natural language descriptions.

According to certain embodiments, the coding system 310 and/or the coding processor 320 generates a first prompt to be provided to the GenAI model based at least in part on an indicator (e.g., a link, etc.) of the input data, one or more user requests (e.g., natural language requests received from a user, etc.), and/or a reference to the representation of the standard coding document (e.g., the hierarchical data model). In some examples, the first prompt includes one or more user requests (e.g., one or more input prompts received from a user, etc.) to the GenAI model to evaluate, for each chapter of the standard coding document, whether or not the chapter applies to the input data. In certain examples, the first prompt includes a portion of the input data and a reference to all the chapters in the standard coding document. In some examples, the portion of the input data includes a portion of the input data relevant to a keyword, for example, based on the one or more user requests. In certain examples, the portion of the input data does not include all of the input data.

According to some embodiments, the coding system 310 and/or the coding processor 320 provides the first prompt to the AI processor 350 (e.g., a server) running the GenAI model. In certain embodiments, the first prompt includes a text string. In some examples, the first prompt includes the input data, and/or a collection of the first-level elements in the hierarchical data model.

According to certain embodiments, the coding system 310 and/or the coding processor 320 receives a first response from the GenAI model indicating which first-level elements, referred to as identified first-level elements, apply to the input data and/or the one or more user requests. In some embodiments, the first response includes one or more responses from the GenAI model, where the one or more responses indicate, for each chapter of the standard coding document, whether or not the chapter applies to the input data and/or the one or more user requests. For example, the one or more user requests include a request for a specific task and the first response includes one or more chapters in the standard coding document related to the specific task.

According to some embodiments, the coding system 310 and/or the coding processor 320 ingests one or more coding guideline documents associated with the standard coding document. In certain embodiments, the coding system 310 and/or the coding processor 320 ingests the one or more guideline documents to generate one or more guideline sections. In certain examples, the coding system 310 and/or the coding processor 320 can ingest one or more coding guideline documents (e.g., a guideline document providing how to code different tasks, etc.).

According to certain embodiments, the coding system 310 and/or the coding processor 320 determines one or more mapping connections between one or more elements in the representation of the standard coding document and one or more guideline sections of the one or more coding guideline documents. In some embodiments, the coding system 310 and/or the coding processor 320 generates a connection map between one or more guideline sections in a coding guideline document and one or more elements in the hierarchical data model (e.g., the hierarchical data structure, the hierarchical graph, etc.). In some embodiments, the coding system 310 and/or the coding processor 320 generates a mapping connection between each guideline section in a coding guideline document and one or more elements in the hierarchical graph. For example, a guideline section is mapped to one or more first-level elements (e.g., chapter elements, etc.), one or more second-level elements (e.g., category elements, etc.), one or more third-level elements (e.g., category elements, etc.), one or more leaf-level elements (e.g., code elements, etc.), and/or the like.

FIG. 5 illustrates an example guideline section mapping 500 according to certain embodiments of the present disclosure. FIG. 5 is merely an example. One of ordinary skill in the art would recognize many variations, alternatives, and modifications. In the example illustrated, a guideline section 510 is mapped to one or more elements 520 (e.g., element 520_1, 520_2, 520_3, . . . 520_N), by one or more mapping connections. In some examples, the guideline section 510 is mapped to elements from different levels. For example, the element 520_1 is a first-level element in a hierarchical graph, the element 520_2 is a second-level element in the hierarchical graph. As another example, the element 520_3 is a leaf-level element in a hierarchical graph, the element 520_N is a second-level element in the hierarchical graph. In certain embodiments, a guideline section 510 can include a data structure including the section name, the section data (e.g., guideline text, etc.), one or more mapping connections to one or more elements in a hierarchical data model, and/or the like. For example, the guideline section 510 describes how to code coexisting criteria such as a first criterion and a second criterion. In some embodiments, a standard code is associated with one or more criteria represented in a guideline section and/or an element description. In certain embodiments, a standard code is associated with two or more criteria represented in a guideline section and/or an element description.

According to some embodiments, for each identified first-level element of the one or more first-level elements identified in the first response, the coding system 310 and/or the coding processor 320 generates a second prompt (or a subsequent prompt, e.g., a third prompt, a fourth prompt, etc.) based at least in part on at least one of one or more second-level elements (or one or more intermediate-level elements, e.g., third-level elements, fourth-level elements, etc.), also referred to as one or more intermediate-level elements that are child elements associated with (e.g., a child element, a grandchild element, etc.) the each identified first-level element, one or more applicable guideline sections, and/or at least a part of the input data. In certain embodiments, the coding system 310 and/or the coding processor 320 identifies at least a part of one or more applicable guideline sections based at least in part on the each identified first-level element and one or more mapping connections. In some embodiments, the coding system 310 and/or the coding processor 320 identifies at least a part of the one or more applicable guideline sections based at least in part on the one or more second-level elements that are child elements of the each identified first-level element and one or more mapping connections (e.g., one or more mapping connections in a respective element data structure, one or more mapping connections in a respective guideline section data structure, etc.). In certain embodiments, when an intermediate-level element is not associated with any guideline section, the coding system 310 and/or the coding processor 320 generates the second prompt and/or subsequent prompt based at least in part on the element description of the intermediate-level element and/or one or more element descriptions of one or more child elements of the intermediate-level element.

According to certain embodiments, the coding system 310 and/or the coding processor 320 provides the second prompt (or a subsequent prompt) to the GenAI model. In some embodiments, the GenAI model includes two or more GenAI models. In certain embodiments, for each identified first-level element (e.g., a chapter element in the hierarchical graph of the standard coding document) of the one or more identified first-level elements, the second prompt includes a prompt request of a traversal of a sub-hierarchical data structure corresponding to the each identified first-level element to identify one or more child elements of the each identified first-level element and/or one or more applicable standard codes. In some embodiments, the coding system 310 and/or the coding processor 320, using the GenAI model, evaluates each second-level element (e.g., each category element) of the first-level element (e.g., the chapter element) and determines whether or not the second-level element applies to the input data. In certain embodiments, the coding system 310 and/or the coding processor 320 iteratively evaluates child elements in the sub-hierarchical data structure one level at a time until it reaches the leaf level. In some embodiments, the coding system 310 and/or the coding processor 320 receives a sub-hierarchical data structure corresponding to an element where each child element in the sub-hierarchical data structure includes an indication of whether each child element is applicable to the input data, which is a model chain of thought.

According to some embodiments, the coding system 310 and/or the coding processor 320 receives a second response (or a subsequent response) from the GenAI model, the second response (or the subsequent response) including one or more applicable standard codes, one or more related elements (e.g., in a hierarchical structure) and/or one or more pieces of supporting evidence. In some examples, the coding system 310 and/or the coding processor 320 receives one or more responses from the GenAI model, wherein the one or more responses indicate, for an applicable chapter of the standard coding document, with respect to each category of the chapter, whether or not the category applies to the input data. In certain examples, if a category of a chapter has been determined by the GenAI model to apply to the input data, the coding system 310 and/or the coding processor 320 determines whether or not this applicable category is related to any coding guideline sections and/or any coding guideline documents associated with the standard coding document. In some examples, if this applicable category is determined to be related to one or more guideline sections, for each related guideline section, the coding system 310 and/or the coding processor 320 includes the content of this related guideline section in a prompt (e.g., the second prompt, a subsequent prompt, etc.) to the GenAI model. In some embodiments, the coding system 310 and/or the coding processor 320 repeats processes 140-150 until a leaf level is reached for each identified first-level element.

According to certain embodiments, the content of the guideline section includes an applicable element and one or more additional elements. In some embodiments, the one or more additional elements are not child elements of the identified first-level elements. In certain embodiments, the coding system 310 and/or the coding processor 320 generates a subsequent prompt based on the element data (e.g., element description, etc.) of at least one of the one or more additional elements. In some examples, the one or more additional elements includes an additional first-level element. In certain examples, the coding system 310 and/or the coding processor 320 traverses a sub-hierarchical data structure corresponding to the additional first-level element (e.g., a chapter element) to identify one or more additional standard codes and/or one or more additional pieces of supporting evidence. In some examples, the one or more additional elements include an additional second-level element and/or an additional intermediate-level element. In certain examples, the coding system 310 and/or the coding processor 320, using the GenAI model, evaluates the additional second-level element (e.g., an additional category element, etc.) and/or the additional intermediate-level element and corresponding child elements to identify one or more additional standard codes and/or one or more additional pieces of supporting evidence. In some examples, the one or more additional standard codes overlap with the one or more standard codes identified based on the one or more identified first-level elements (e.g., indicated in the first response, etc.).

According to some embodiments, the coding system 310 and/or the coding processor 320 provides one or more subsequent prompts to the AI processor 350 running the GenAI model. In certain embodiments, the coding system 310 and/or the coding processor 320 provides a subsequent prompt to determine whether the one or more additional elements (e.g., additional categories) are applicable to the input data. In some embodiments, for each category that has been determined to be applicable, the coding system 310 and/or the coding processor 320 determines which standard code(s) of the category applies to the input data. In some embodiments, the coding system 310 and/or the coding processor 320 generates one or more output datasets (e.g., applicable standard codes, etc.), for example, receiving from the GenAI model, for the patient. In certain embodiments, the coding system 310 and/or the coding processor 320 generates the one or more output datasets that include one or more applicable codes and one or more pieces of supporting evidence extracted from the input data.

According to certain embodiments, the coding system 310 and/or the coding processor 320 generates one or more output datasets. In some embodiments, the coding system 310 and/or the coding processor 320 identifies one or more guideline sections related to the one or more identified first-level elements and/or one or more child elements of the one or more identified first-level elements. In certain embodiments, the coding system 310 and/or the coding processor 320 generates a prompt for each related guideline section to identify one or more standard codes and/or one or more pieces of supporting evidence. In some embodiments, the coding system 310 and/or the coding processor 320 generates two or more prompts for two or more related guideline sections to identify one or more standard codes and/or one or more pieces of supporting evidence. In certain embodiments, the one or more output datasets include the one or more standard codes, the one or more related elements in the sub-hierarchical data structure (e.g., each element indicating applicable or not, etc.) and/or the one or more pieces of supporting evidence. In some embodiments, at least one of the one or more pieces of supporting evidence is extracted from the input data. In certain embodiments, at least one of the one or more pieces of supporting evidence is extracted from a coding guideline section and/or a coding guideline document. In some embodiments, at least one of the one or more pieces of supporting evidence is extracted from an element description of an element in the hierarchical data model.

FIG. 6 is an illustrative example of an output dataset 600 (e.g., a submission) according to certain embodiments of the present disclosure. FIG. 6 is merely an example. One of ordinary skill in the art would recognize many variations, alternatives, and modifications. In the example illustrated, the output dataset 600 includes one or more standard codes 610, one or more sub-hierarchical data structures 620, and one or more pieces of supporting evidence 630. In some embodiments, the sub-hierarchical data structure 620 is a subset of the hierarchical data model representing the standard coding document. In certain embodiments, each element 625 in the sub-hierarchical data structure 620 has an indication of whether the element 625 is applicable to the input data. In some embodiments, a piece of supporting evidence 630 includes one or more highlighted sections 635.

According to certain embodiments, when the coding process takes place, the evaluation information for each element in the hierarchical data model are maintained to allow users to review and/or audit a model chain of thought. In some examples, some existing coding technologies do not utilize external information (e.g., coding guidelines, etc.), and have no prompting structure. As such, in certain embodiments, the coding system can improve the efficiency in using the GenAI model and reduce hallucinations of the GenAI model for the standard coding processes.

According to some embodiments, the coding system 310 and/or the coding processor 320 sends the one or more output datasets for human review (e.g., reviewed by case managers, etc.) and/or to a third-party system (e.g., a client system). In certain examples, the human reviewer can modify the one or more output datasets to generate one or more revised output datasets to send to the third-party system and/or a software module of the coding system. In some examples, the human reviewer can modify the one or more output datasets to generate one or more revised output datasets to send a subsequent human review (e.g., by a supervisor, etc.).

In some embodiments, one or more data repositories 330 include one or more standard coding documents and/or guidelines 332. In certain embodiments, the computing device 340 may include and/or access at least a part of the functionality of the coding system 310. Although the above has been shown using a selected group of components in the computing environment 300, there can be many alternatives, modifications, and variations. For example, some of the components may be expanded and/or combined. Other components may be inserted into those noted above. Depending upon the embodiment, the arrangement of components may be interchanged with others replaced. Further details of these components are found throughout the present disclosure.

In some embodiments, the one or more data repositories 330 can include one or more standard coding documents, one or more coding guideline documents, one or more hierarchical data models, one or more input datasets, one or more prompts, one or more prompt structures, one or more standard codes, one or more mapping connections, and/or the like. The repository may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by a data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central. In some cases, various components in the computing environment 300 can execute software or firmware stored in a non-transitory computer-readable medium to implement various processing steps. Various components and processors of the computing environment 300 can be implemented by one or more computing devices including, but not limited to, circuits, a computer, a cloud-based processing unit, a processor, a processing unit, a microprocessor, a mobile computing device, and/or a tablet computer. In some cases, various components referenced by the computing environment 300 (e.g., the one or more coding systems 310, the one or more coding processor 320, the one or more computing devices 340, etc.) can be implemented on a shared computing device. Alternatively, a component of the computing environment 300 can be implemented on multiple computing devices. In some implementations, various modules and components referenced by the computing environment 300 can be implemented as software, hardware, firmware, or a combination thereof. In some cases, various components referenced by the computing environment 300 can be implemented in software or firmware executed by a computing device.

Various components referenced by the computing environment 300 can communicate via or be coupled to via a communication interface, for example, a wired or wireless interface. The communication interface includes, but is not limited to, any wired or wireless short-range and long-range communication interfaces. The short-range communication interfaces may be, for example, a local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, a wide area network (WAN), cellular network interfaces, satellite communication interfaces, etc. The communication interface may be either within a private computer network, such as an intranet, or on a public computer network, such as the Internet.

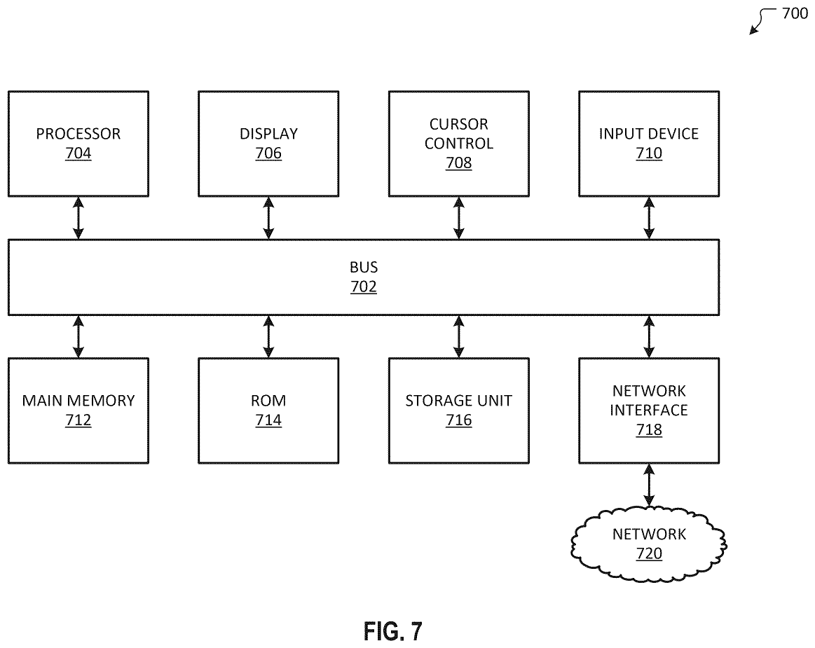

FIG. 7 is a simplified diagram showing a computing system for implementing a system 700 for standard coding processes in accordance with at least one example set forth in the disclosure. This diagram is merely an example, which should not unduly limit the scope of the claims. One of ordinary skill in the art would recognize many variations, alternatives, and modifications.

The computing system 700 includes a bus 702 or other communication mechanism for communicating information, a processor 704, a display 706, a cursor control component 708, an input device 710, a main memory 712, a read only memory (ROM) 714, a storage unit 716, and a network interface 718. In some embodiments, some or all processes (e.g., steps) of the methods and/or processes (e.g., the method 100, the method 200, etc.) disclosed herein are performed by the computing system 700. In some embodiments, the bus 702 is coupled to the processor 704, the display 706, the cursor control component 708, the input device 710, the main memory 712, the read only memory (ROM) 714, the storage unit 716, and/or the network interface 718. In certain embodiments, the network interface is coupled to a network 720. For example, the processor 704 includes one or more general purpose microprocessors. In some embodiments, the main memory 712 (e.g., random access memory (RAM), cache and/or other dynamic storage devices) is configured to store information and instructions to be executed by the processor 704. In certain embodiments, the main memory 712 is configured to store temporary variables or other intermediate information during execution of instructions to be executed by processor 704. For example, the instructions, when stored in the storage unit 716 accessible to processor 704, render the computing system 700 into a special-purpose machine that is customized to perform the operations specified in the instructions. In some embodiments, the ROM 714 is configured to store static information and instructions for the processor 704. In certain embodiments, the storage unit 716 (e.g., a magnetic disk, optical disk, or flash drive) is configured to store information and instructions.

In some embodiments, the display 706 (e.g., a cathode ray tube (CRT), an LCD display, or a touch screen) is configured to display information to a user of the computing system 700. In some embodiments, the input device 710 (e.g., alphanumeric and other keys) is configured to communicate information and commands to the processor 704. For example, the cursor control component 708 (e.g., a mouse, a trackball, or cursor direction keys) is configured to communicate additional information and commands (e.g., to control cursor movements on the display 706) to the processor 704.

According to certain embodiments, a method for standard coding processes is provided. In some examples, the method includes receiving input data, the input data including unstructured text data; accessing a hierarchical data model representing a standard coding document, the standard coding document including a set of standard codes, the hierarchical data structure including one or more levels, each level of the one or more levels including one or more elements; generating a first prompt based on the input data, the first prompt including a request of relevant first-level elements of a plurality of first-level elements, the plurality of first-level elements being of a first level of the one or more levels; providing the first prompt to a generative artificial intelligence (GenAI) model; receiving a first response from the GenAI model, the first response including an indication indicative of one or more identified first-level elements of the plurality of first-level elements; identifying one or more intermediate-level elements associated with the one or more identified first-level elements, each intermediate-level element of the one or more intermediate-level elements being a child element associated with at least one of the one or more identified first-level elements; generating a second prompt based at least in part on the one or more identified intermediate-level elements and the input data; providing the second prompt to the GenAI model; and receiving a second response from the GenAI model based on the hierarchical data model, the second response including one or more applicable standard codes in the set of standard codes. The method is performed using one or more processors. For example, the method is implemented according to at least FIG. 1, FIG. 2, and/or FIG. 3.

In some embodiments, the second response includes one or more pieces of supporting evidence, wherein a first piece of supporting evidence of the one or more pieces of supporting evidence is extracted from the input data. In some embodiments, the method further comprises: accessing a coding guideline document associated with the standard coding document; identifying one or more guideline sections associated with at least one of the one or more identified intermediate-level elements; wherein the generating a second prompt includes generating the second prompt based at least in part on the one or more identified intermediate-level elements, the one or more guideline sections, and the input data. In certain embodiments, a second piece of supporting evidence of the one or more pieces of supporting evidence is extracted from the one or more guideline sections. In some embodiments, the method further comprises: generating an output based on the one or more applicable standard codes and the one or more pieces of supporting evidence. In some embodiments, the method further comprises: providing the output to human review or a third-party system.

In some embodiments, the method further comprises: causing display of an indication of the one or more applicable standard codes and the one or more pieces of supporting evidence. In some embodiments, the method further comprises: accessing a coding guideline document associated with the standard coding document; identifying one or more guideline sections associated with at least one of the one or more identified intermediate-level elements; wherein the generating a second prompt includes generating the second prompt based at least in part on the one or more identified intermediate-level elements, the one or more guideline sections, and the input data. In some embodiments, the method further comprises: determining that at least one of the one or more guideline sections include an additional intermediate-level element, the additional intermediate-level element not being any child elements associated with the one or more identified first-level elements; generating a subsequent prompt based at least in part on the additional intermediate-level element and the input data.

In some embodiments, the method further comprises: generating one or more mapping connections for the coding guideline document and the standard coding document, a mapping connection mapping a guideline section to an element in the hierarchical data model; wherein the identifying one or more guideline sections associated with at least one of the one or more identified intermediate-level elements includes identifying one or more guideline sections associated with at least one of the one or more identified intermediate-level elements based on the one or more mapping connections. In some embodiments, the method further comprises: causing a traversal of a sub-hierarchical data structure corresponding to one of the one or more identified first-level elements, the sub-hierarchical data structure corresponding to a part of the hierarchical data model; wherein each element in the sub-hierarchical data structure has an indication of whether the each element is applicable to the input data. In certain embodiments, the hierarchical data model includes one or more leaf-level elements, wherein the one or more leaf-level elements include at least a part of the set of standard codes.

According to certain embodiments, a system for standard coding processes is provided. In some examples, the system includes: one or more memories comprising instructions stored thereon; and one or more processors configured to execute the instructions and perform a set of operations comprising: receiving input data, the input data including unstructured text data; accessing a hierarchical data model representing a standard coding document, the standard coding document including a set of standard codes, the hierarchical data structure including one or more levels, each level of the one or more levels including one or more elements; generating a first prompt based on the input data, the first prompt including a request of relevant first-level elements of a plurality of first-level elements, the plurality of first-level elements being of a first level of the one or more levels; providing the first prompt to a generative artificial intelligence (GenAI) model; receiving a first response from the GenAI model, the first response including an indication indicative of one or more identified first-level elements of the plurality of first-level elements; identifying one or more intermediate-level elements associated with the one or more identified first-level elements, each intermediate-level element of the one or more intermediate-level elements being a child element associated with at least one of the one or more identified first-level elements; generating a second prompt based at least in part on the one or more identified intermediate-level elements and the input data; providing the second prompt to the GenAI model; and receiving a second response from the GenAI model based on the hierarchical data model, the second response including one or more applicable standard codes in the set of standard codes. For example, the system is implemented according to at least FIG. 1, FIG. 2, and/or FIG. 3.

In some embodiments, the second response includes one or more pieces of supporting evidence, wherein a first piece of supporting evidence of the one or more pieces of supporting evidence is extracted from the input data. In some embodiments, the set of operations further comprise: accessing a coding guideline document associated with the standard coding document; identifying one or more guideline sections associated with at least one of the one or more identified intermediate-level elements; wherein the generating a second prompt includes generating the second prompt based at least in part on the one or more identified intermediate-level elements, the one or more guideline sections, and the input data. In certain embodiments, a second piece of supporting evidence of the one or more pieces of supporting evidence is extracted from the one or more guideline sections. In some embodiments, the set of operations further comprise: generating an output based on the one or more applicable standard codes and the one or more pieces of supporting evidence. In some embodiments, the set of operations further comprise: providing the output to human review or a third-party system.

In some embodiments, the set of operations further comprise: causing display of an indication of the one or more applicable standard codes and the one or more pieces of supporting evidence. In some embodiments, the set of operations further comprise: accessing a coding guideline document associated with the standard coding document; identifying one or more guideline sections associated with at least one of the one or more identified intermediate-level elements; wherein the generating a second prompt includes generating the second prompt based at least in part on the one or more identified intermediate-level elements, the one or more guideline sections, and the input data. In some embodiments, the set of operations further comprise: determining that at least one of the one or more guideline sections include an additional intermediate-level element, the additional intermediate-level element not being any child elements associated with the one or more identified first-level elements; generating a subsequent prompt based at least in part on the additional intermediate-level element and the input data.

In some embodiments, the set of operations further comprise: generating one or more mapping connections for the coding guideline document and the standard coding document, a mapping connection mapping a guideline section to an element in the hierarchical data model; wherein the identifying one or more guideline sections associated with at least one of the one or more identified intermediate-level elements includes identifying one or more guideline sections associated with at least one of the one or more identified intermediate-level elements based on the one or more mapping connections. In some embodiments, the set of operations further comprise: causing a traversal of a sub-hierarchical data structure corresponding to one of the one or more identified first-level elements, the sub-hierarchical data structure corresponding to a part of the hierarchical data model; wherein each element in the sub-hierarchical data structure has an indication of whether the each element is applicable to the input data. In certain embodiments, the hierarchical data model includes one or more leaf-level elements, wherein the one or more leaf-level elements include at least a part of the set of standard codes.

According to certain embodiments, a non-transitory computer-readable storage medium having instructions for standard coding processes that, when executed by one or more processors, cause the one or more processors to perform a set of operations comprising: receiving input data, the input data including unstructured text data; accessing a hierarchical data model representing a standard coding document, the standard coding document including a set of standard codes, the hierarchical data structure including one or more levels, each level of the one or more levels including one or more elements; generating a first prompt based on the input data, the first prompt including a request of relevant first-level elements of a plurality of first-level elements, the plurality of first-level elements being of a first level of the one or more levels; providing the first prompt to a generative artificial intelligence (GenAI) model; receiving a first response from the GenAI model, the first response including an indication indicative of one or more identified first-level elements of the plurality of first-level elements; identifying one or more intermediate-level elements associated with the one or more identified first-level elements, each intermediate-level element of the one or more intermediate-level elements being a child element associated with at least one of the one or more identified first-level elements; generating a second prompt based at least in part on the one or more identified intermediate-level elements and the input data; providing the second prompt to the GenAI model; and receiving a second response from the GenAI model based on the hierarchical data model, the second response including one or more applicable standard codes in the set of standard codes. For example, the non-transitory computer-readable storage medium is implemented according to at least FIG. 1, FIG. 2, and/or FIG. 3.

In some embodiments, the second response includes one or more pieces of supporting evidence, wherein a first piece of supporting evidence of the one or more pieces of supporting evidence is extracted from the input data. In some embodiments, the set of operations further comprise: accessing a coding guideline document associated with the standard coding document; identifying one or more guideline sections associated with at least one of the one or more identified intermediate-level elements; wherein the generating a second prompt includes generating the second prompt based at least in part on the one or more identified intermediate-level elements, the one or more guideline sections, and the input data. In certain embodiments, a second piece of supporting evidence of the one or more pieces of supporting evidence is extracted from the one or more guideline sections. In some embodiments, the set of operations further comprise: generating an output based on the one or more applicable standard codes and the one or more pieces of supporting evidence. In some embodiments, the set of operations further comprise: providing the output to human review or a third-party system.

In some embodiments, the set of operations further comprise: causing display of an indication of the one or more applicable standard codes and the one or more pieces of supporting evidence. In some embodiments, the set of operations further comprise: accessing a coding guideline document associated with the standard coding document; identifying one or more guideline sections associated with at least one of the one or more identified intermediate-level elements; wherein the generating a second prompt includes generating the second prompt based at least in part on the one or more identified intermediate-level elements, the one or more guideline sections, and the input data. In some embodiments, the set of operations further comprise: determining that at least one of the one or more guideline sections include an additional intermediate-level element, the additional intermediate-level element not being any child elements associated with the one or more identified first-level elements; generating a subsequent prompt based at least in part on the additional intermediate-level element and the input data.

In some embodiments, the set of operations further comprise: generating one or more mapping connections for the coding guideline document and the standard coding document, a mapping connection mapping a guideline section to an element in the hierarchical data model; wherein the identifying one or more guideline sections associated with at least one of the one or more identified intermediate-level elements includes identifying one or more guideline sections associated with at least one of the one or more identified intermediate-level elements based on the one or more mapping connections. In some embodiments, the set of operations further comprise: causing a traversal of a sub-hierarchical data structure corresponding to one of the one or more identified first-level elements, the sub-hierarchical data structure corresponding to a part of the hierarchical data model; wherein each element in the sub-hierarchical data structure has an indication of whether the each element is applicable to the input data. In certain embodiments, the hierarchical data model includes one or more leaf-level elements, wherein the one or more leaf-level elements include at least a part of the set of standard codes.

For example, some or all components of various embodiments of the present disclosure each are, individually and/or in combination with at least another component, implemented using one or more software components, one or more hardware components, and/or one or more combinations of software and hardware components. In an example, some or all components of various embodiments of the present disclosure each are, individually and/or in combination with at least another component, implemented in one or more circuits, such as one or more analog circuits and/or one or more digital circuits. In an example, while the embodiments described above refer to particular features, the scope of the present disclosure also includes embodiments having different combinations of features and embodiments that do not include all of the described features. In an example, various aspects of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations, one or more features from a combination can in some cases be removed from the combination, and a combination may, for example, be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for standard coding processes, the method comprising:
receiving input data, the input data including unstructured text data;
accessing a hierarchical data model representing a standard coding document, the standard coding document including a set of standard codes, the hierarchical data model including one or more levels, each level of the one or more levels including one or more elements;
generating a first prompt based on the input data, the first prompt including a request of relevant first-level elements of a plurality of first-level elements, the plurality of first-level elements being of a first level of the one or more levels;
providing the first prompt to a generative artificial intelligence (GenAI) model;
receiving a first response from the GenAI model, the first response including an indication indicative of one or more identified first-level elements of the plurality of first-level elements;
identifying one or more intermediate-level elements associated with the one or more identified first-level elements, each identified intermediate-level element of the one or more identified intermediate-level elements being a child element associated with at least one of the one or more identified first-level elements;
generating a second prompt based at least in part on the one or more identified intermediate-level elements and the input data;
providing the second prompt to the GenAI model; and
receiving a second response from the GenAI model based on the hierarchical data model, the second response including one or more applicable standard codes in the set of standard codes;
wherein the method is performed using one or more processors.

2. The method of claim 1, wherein the second response includes one or more pieces of supporting evidence, wherein a first piece of supporting evidence of the one or more pieces of supporting evidence is extracted from the input data.

3. The method of claim 2, further comprising:
accessing a coding guideline document associated with the standard coding document;
identifying one or more guideline sections associated with at least one of the one or more identified intermediate-level elements;
wherein the generating a second prompt includes generating the second prompt based at least in part on the one or more identified intermediate-level elements, the one or more guideline sections, and the input data.

4. The method of claim 3, wherein a second piece of supporting evidence of the one or more pieces of supporting evidence is extracted from the one or more guideline sections.

5. The method of claim 4, further comprising:
generating an output based on the one or more applicable standard codes and the one or more pieces of supporting evidence.

6. The method of claim 5, further comprising:
providing the output to human review or a third-party system.

7. The method of claim 4, further comprising:
causing display of an indication of the one or more applicable standard codes and the one or more pieces of supporting evidence.

8. The method of claim 1, further comprising:
accessing a coding guideline document associated with the standard coding document;
identifying one or more guideline sections associated with at least one of the one or more identified intermediate-level elements;
wherein the generating a second prompt includes generating the second prompt based at least in part on the one or more identified intermediate-level elements, the one or more guideline sections, and the input data.

9. The method of claim 8, further comprising:
determining that at least one of the one or more guideline sections include an additional intermediate-level element, the additional intermediate-level element not being any child elements associated with the one or more identified first-level elements;
generating a subsequent prompt based at least in part on the additional intermediate-level element and the input data.

10. The method of claim 8, further comprising:
generating one or more mapping connections for the coding guideline document and the standard coding document, a mapping connection mapping a guideline section to an element in the hierarchical data model;
wherein the identifying one or more guideline sections associated with at least one of the one or more identified intermediate-level elements includes identifying the one or more guideline sections associated with at least one of the one or more identified intermediate-level elements based on the one or more mapping connections.

11. The method of claim 1, further comprising:
causing a traversal of a sub-hierarchical data structure corresponding to one of the one or more identified first-level elements, the sub-hierarchical data structure corresponding to a part of the hierarchical data model;
wherein each element in the sub-hierarchical data structure has an indication of whether the each element is applicable to the input data.

12. The method of claim 1, wherein the hierarchical data model includes one or more leaf-level elements, wherein the one or more leaf-level elements include at least a part of the set of standard codes.

13. A system for standard coding processes, the system comprising:
one or more memories comprising instructions stored thereon; and
one or more processors configured to execute the instructions and perform a set of operations comprising:
receiving input data, the input data including unstructured text data;
accessing a hierarchical data model representing a standard coding document, the standard coding document including a set of standard codes, the hierarchical data model including one or more levels, each level of the one or more levels including one or more elements;
generating a first prompt based on the input data, the first prompt including a request of relevant first-level elements of a plurality of first-level elements, the plurality of first-level elements being of a first level of the one or more levels;
providing the first prompt to a generative artificial intelligence (GenAI) model;
receiving a first response from the GenAI model, the first response including an indication indicative of one or more identified first-level elements of the plurality of first-level elements;
identifying one or more intermediate-level elements associated with the one or more identified first-level elements, each identified intermediate-level element of the one or more identified intermediate-level elements being a child element associated with at least one of the one or more identified first-level elements;
generating a second prompt based at least in part on the one or more identified intermediate-level elements and the input data;
providing the second prompt to the GenAI model; and
receiving a second response from the GenAI model based on the hierarchical data model, the second response including one or more applicable standard codes in the set of standard codes.

14. The system of claim 13, wherein the second response includes one or more pieces of supporting evidence, wherein a first piece of supporting evidence of the one or more pieces of supporting evidence is extracted from the input data.

15. The system of claim 14, wherein the set of operations further comprise:
accessing a coding guideline document associated with the standard coding document;
identifying one or more guideline sections associated with at least one of the one or more identified intermediate-level elements;
wherein the generating a second prompt includes generating the second prompt based at least in part on the one or more identified intermediate-level elements, the one or more guideline sections, and the input data.

16. The system of claim 15, wherein a second piece of supporting evidence of the one or more pieces of supporting evidence is extracted from the one or more guideline sections.

17. The method of claim 16, wherein the set of operations further comprise:
generating an output based on the one or more applicable standard codes and the one or more pieces of supporting evidence.

18. The system of claim 13, wherein the set of operations further comprise:
accessing a coding guideline document associated with the standard coding document;
identifying one or more guideline sections associated with at least one of the one or more identified intermediate-level elements;
wherein the generating a second prompt includes generating the second prompt based at least in part on the one or more identified intermediate-level elements, the one or more guideline sections, and the input data.

19. The system of claim 18, wherein the set of operations further comprise:
determining that at least one of the one or more guideline sections include an additional intermediate-level element, the additional intermediate-level element not being any child elements associated with the one or more identified first-level elements;
generating a subsequent prompt based at least in part on the additional intermediate-level element and the input data.

20. A non-transitory computer-readable storage medium having instructions for standard coding processes that, when executed by one or more processors, cause the one or more processors to perform a set of operations comprising:
receiving input data, the input data including unstructured text data;
accessing a hierarchical data model representing a standard coding document, the standard coding document including a set of standard codes, the hierarchical data model including one or more levels, each level of the one or more levels including one or more elements;
generating a first prompt based on the input data, the first prompt including a request of relevant first-level elements of a plurality of first-level elements, the plurality of first-level elements being of a first level of the one or more levels;
providing the first prompt to a generative artificial intelligence (GenAI) model;
receiving a first response from the GenAI model, the first response including an indication indicative of one or more identified first-level elements of the plurality of first-level elements;
identifying one or more intermediate-level elements associated with the one or more identified first-level elements, each identified intermediate-level element of the one or more identified intermediate-level elements being a child element associated with at least one of the one or more identified first-level elements;
generating a second prompt based at least in part on the one or more identified intermediate-level elements and the input data;
providing the second prompt to the GenAI model; and
receiving a second response from the GenAI model based on the hierarchical data model, the second response including one or more applicable standard codes in the set of standard codes.
